(19) United States
(12) Patent Application Publication
(10) Pub. No.: US 2016/0096513 A1
(43) Pub. Date: Apr. 7, 2016

(54) DRIVE SHAFT MOUNTED EMERGENCY BRAKE

(71) Applicant: Umm Al-Qura University, Makkah (SA)

(72) Inventor: Othman Ali Khalid Alasmari, Makkah (SA)

(73) Assignee: Umm Al-Qura University

(21) Appl. No.: 14/506,447

(22) Filed: Oct. 3, 2014

(51) Int. Cl. B60T 1/00; F16D 69/02; B60T 11/04; F16D 49/08

(52) U.S. Cl. CPC B60T 1/005; F16D 49/08; F16D 69/027; B60T 11/046

(57) ABSTRACT

An emergency braking system for a vehicle, said system being independent of the primary service braking system for the vehicle, wherein the system includes a first cone-shaped copper brake member mounted coaxially on the vehicle drive shaft for limited axial movement but is prevented from rotation by cooperation with a housing fixed to the vehicle chassis, and a second cone-shaped copper brake member fixed coaxially on the drive shaft for rotation with the drive shaft and telescopically received in the first brake member. A cable extends from the first brake member to the cabin of the vehicle so that the driver can move the first brake member axially into contact with the second brake member to slow or stop the vehicle. The first brake member is normally biased out of contact with the second brake member.

### TECHNICAL FIELD

This invention relates to emergency brakes for motor vehicles, and particularly to an emergency brake that has a first rotational brake element fixed to the drive shaft for rotation with the drive shaft, and a second non-rotational brake element attached to the chassis of the vehicle and mounted for movement into contact with the rotational element to apply a braking force to the vehicle.

### BACKGROUND ART

Emergency brakes are generally known in motor vehicles to prevent unintended movement of the vehicle when the engine is shut off, i.e. a parking brake. However, as the name implies, emergency brakes are also intended to stop or slow down the vehicle in the event of failure of the primary braking system. Conventional emergency/parking brakes generally are mounted on the wheels of the vehicle and comprise a back-up means for actuating the primary brake components when the primary actuation system fails.

Commercial vehicles, especially those over a certain size, typically are equipped with air brakes that use compressed air to operate the brakes. An air brake system is three braking systems combined: (1) the service brake system that applies and releases the brakes when the brake pedal is used during normal driving; (2) the parking brake system that applies and releases the parking brakes when the parking brake control is used; and (3) the emergency brake system that uses parts of the service and parking brake systems to stop the vehicle in the event of a brake system failure. To meet safety regulations, vehicles of a size sufficient to require full power controls for steering and brakes are usually equipped with a backup source of pressurized hydraulic or pneumatic fluid. Such backup source is normally in the form of an auxiliary pump driven by an electric motor receiving power from the vehicle battery so that the vehicle may be steered and stopped under emergency conditions where the main engine or regular hydraulic pump has failed. However, these systems generally still use the primary service brakes.

Such systems not only assume that the battery will have sufficient stored power to operate long enough to bring the vehicle to a stop but also assume that any failure will be correctable by having available an auxiliary source of pressurized fluid. However, such systems are not capable of stopping the vehicle when failure occurs by reason of inability to utilize the pressurized fluid as, for example, when the brake lines or wheel cylinders are ruptured, thereby preventing the brakes at the individual wheels from being operated.

There is a need for an emergency brake that is entirely independent of the primary braking system and that can be engaged even if there is a catastrophic failure of the primary system and/or loss of on-board power.

### SUMMARY OF THE INVENTION

The present invention comprises an emergency braking system that is completely independent of the normal primary braking system and that can be engaged even if there is a catastrophic failure of the primary system and/or loss of on-board power.

The emergency braking system of the invention is capable of stopping the vehicle when all else fails, when there is no power aboard the vehicle or when there has been a catastrophic failure of the primary braking system by rupture of the regular hydraulic or pneumatic brake lines or brake cylinders, for example.

The emergency braking system of the invention comprises a first non-rotational brake member mounted for limited axial movement in a housing fixed to the vehicle chassis, and a second brake member fixed to the drive shaft for rotation with the drive shaft. A cable extends from the first brake member to the cabin of the vehicle so that the driver can pull the cable and move the first brake member axially into contact with the second brake member to impede rotation of the second brake member and thus impede rotation of the drive shaft to slow or stop the vehicle. The first brake member is normally biased out of contact with the second brake member by spring means.

In a preferred embodiment the first and second brake members are cone shaped, and in a further preferred embodiment they are made of copper.

### BRIEF DESCRIPTION OF THE DRAWINGS

The foregoing, as well as other objects and advantages of the invention, will become apparent from the following detailed description when taken in conjunction with the accompanying drawings, wherein like reference characters designate like parts throughout the several views, and wherein:

FIG. 1 is a somewhat schematic plan view of the emergency brake system of the invention, with the emergency brake shown disengaged.

FIG. 2 is an enlarged fragmentary isometric view of an embodiment of the emergency brake of the invention, shown in engaged position and with portions broken away and the housing and supports shown in broken lines.

FIG. 3 is a longitudinal sectional view taken along line 3-3 in FIG. 4.

FIG. 4 is a longitudinal sectional view taken along line 4-4 in FIG. 3.

FIG. 5 is an enlarged fragmentary isometric view, with portions broken away, of an alternate embodiment in which the housing is flanged to enable access to the brake cones.

### DETAILED DESCRIPTION OF THE PREFERRED EMBODIMENTS

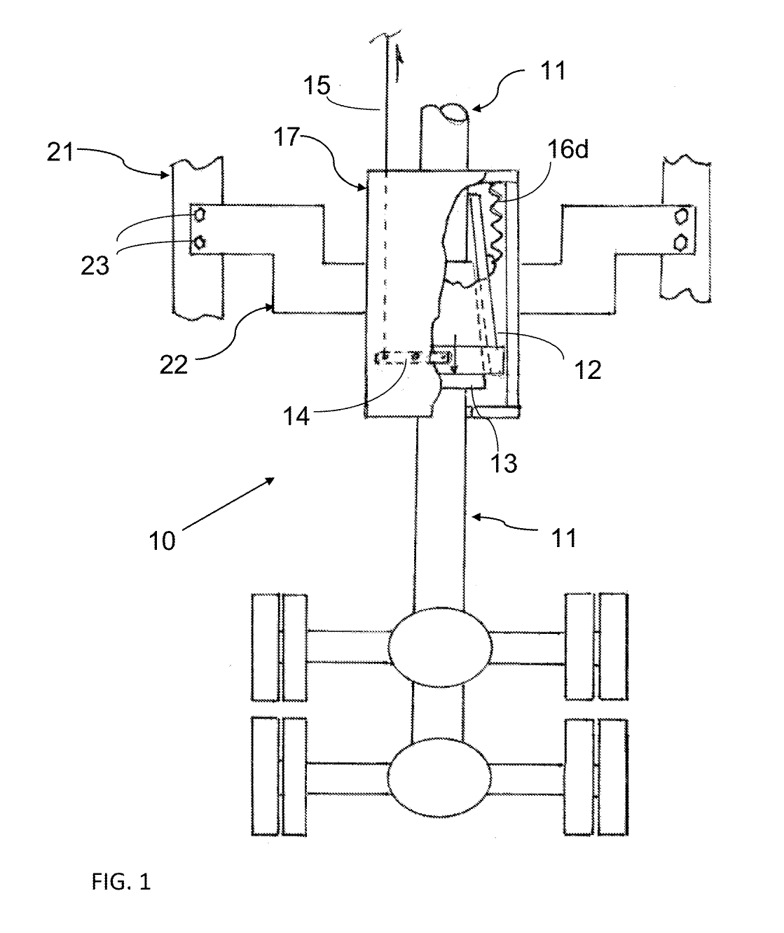

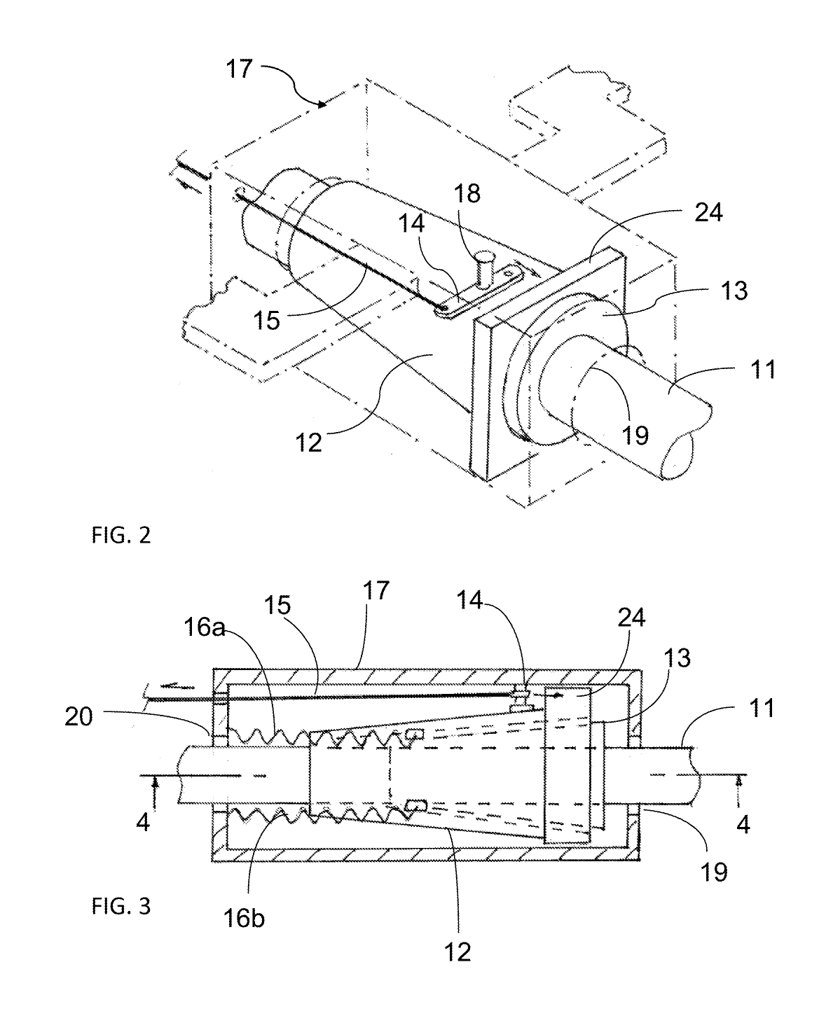

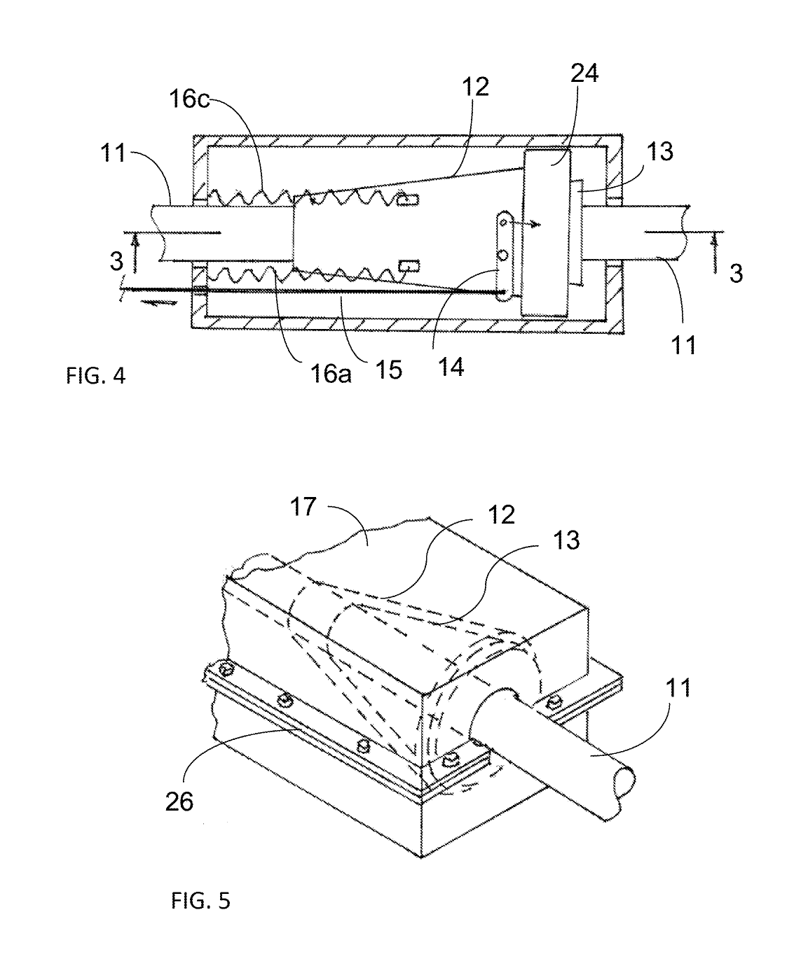

An emergency brake system according to the invention is indicated generally at 10 in FIG. 1. The emergency brake is applied to the drive shaft 11 of a vehicle and comprises a first non-rotational brake member 12 mounted for limited axial movement on the drive shaft, and a second brake member 13 immovably fixed to the drive shaft for rotation with the drive shaft. A pivot arm 14 has one end connected to the first brake member and the other end connected with a cable 15 that extends into the cabin of the vehicle so that the driver can pull the cable to pivot the pivot arm and move the first brake member into frictional engagement with the second brake member to slow or stop rotation of the drive shaft and thereby slow or stop movement of the vehicle. The first brake member normally is biased out of contact with the second brake member by suitable biasing means, which in the example described herein comprises four springs 16a-16d connected between the first brake member and a housing 17 surrounding the first and second brake members.

In the particular example described herein, the first and second brake members 12 and 13 are made of copper, are cone shaped and are coaxially arranged on the drive shaft. The pivot arm 14 is pivotally attached to the underside of the top wall of the housing 17 by pivot 18, and the cable 15 extends from the arm through an opening in the end of the housing. The drive shaft extends through openings 19 and 20 in respective opposite ends of the housing, and in a preferred embodiment the openings provide clearance for the drive shaft and permit some lateral movement of the drive shaft relative to the housing during operation of the vehicle. If desired, flexible seals (not shown) could be provided in these openings between the drive shaft and housing to prevent entry of dirt and moisture through the openings.

The housing 17 is immovably supported on the vehicle chassis 21 by supports 22 secured to the chassis as by bolts 23 and it has a non-circular transverse cross-sectional shape at least on its inner surface. The first brake member 12 has correspondingly shaped collar 24 on its forward end slidably engaged in the housing so that the first brake member has limited axial movement toward and away from the second brake member 13 but is constrained against rotational movement due to the mating non-circular shapes of the housing inner surface and the collar. In the example described herein, the housing and collar are rectangular in shape but other means could be provided to prevent rotation of the first brake member in the housing.

The second brake member can be secured to the drive shaft in any suitable manner, such as by a press-fit between the brake member and drive shaft as shown in the drawings, or by welds, dowels, or other suitable means, not shown.

In a particular example of the invention the second brake member has thickness of about 2 cm at its larger end, and the first brake member moves axially about 1 cm from its inactive position to its fully engaged position with the second brake member.

As shown in FIG. 5, the top and bottom halves of the housing could be made separable and secured together by bolted flanges 26 on their confronting edges.

The first brake member has to move axially only 1 or 2 cm in order to bring the confronting conical surfaces of the first and second brake members into contact with one another, although this distance could be greater or less, as desired or necessary for proper operation.

Instead of using a cable acting on a pivot arm to move the first brake member into contact with the second brake member, and a spring or springs to move them apart, other suitable means (not shown) such as electromechanical, hydraulic or pneumatic means separate from the primary service brake system could be used to move the brake members into and out of contact with one another.

While particular embodiments of the invention have been illustrated and described in detail herein, it should be understood that various changes and modifications may be made in the invention without departing from the spirit and intent of the invention as defined by the appended claims.

What is claimed is:

1. An emergency brake system for a vehicle having a drive shaft and a chassis, wherein the emergency brake system is independent of the primary service brake system of the vehicle and comprises:
a first brake member mounted in a housing so that the first brake member has limited axial movement but is constrained against rotational movement;
a second brake member fixed to the drive shaft for rotation with the drive shaft, said first brake member being movable into frictional engagement with the second brake member to impede rotation of the second brake member and thus impede rotation of said drive shaft and thereby slow or stop movement of said vehicle; and
actuating means connected with the first brake member to enable a driver of the vehicle to move the first brake member into engagement with the second brake member and stop the vehicle.

2. The emergency brake system as claimed in claim 1, wherein:
the actuating means comprises a cable extending from the first brake member to a cabin of the vehicle so that the driver can pull the cable and move the first brake member axially into contact with the second brake member.

3. The emergency brake system as claimed in claim 2, wherein:
spring means is connected with the first brake member to normally bias it out of contact with the second brake member.

4. The emergency brake system as claimed in claim 3, wherein:
said housing is fixed to said vehicle chassis by supports.

5. The emergency brake system as claimed in claim 4, wherein:
said first and second brake members are cone shaped and are mounted coaxially on said drive shaft.

6. The emergency brake system as claimed in claim 5, wherein:
said cone-shaped brake members are made of copper.

7. The emergency brake system as claimed in claim 1, wherein:
said first and second brake members are cone shaped and are mounted coaxially on said drive shaft.

8. The emergency brake system as claimed in claim 7, wherein:
said cone-shaped brake members are made of copper.

9. The emergency brake system as claimed in claim 6, wherein:
said housing has an interior surface that is non-circular in transverse cross-section; and
said first brake member has a complementally shaped non-circular outer surface slidably engaged with the housing interior surface to prevent rotation of said first brake member.

10. The emergency brake system as claimed in claim 1, wherein:
said housing has an interior surface that is non-circular in transverse cross-section; and
said first brake member has a complementally shaped non-circular outer surface slidably engaged with the housing interior surface to prevent rotation of said first brake member.

11. The emergency brake system as claimed in claim 10, wherein:
said first and second brake members are cone shaped and are mounted coaxially on said drive shaft.

12. The emergency brake system as claimed in claim 11, wherein:
said cone-shaped brake members are made of copper.
